(19) United States
(12) Patent Application Publication
(10) Pub. No.: US 2026/0235238 A1
(43) Pub. Date: Aug. 13, 2026

(54) CLAMP HAVING A FLAG

(71) Applicant: Ford Global Technologies, LLC, Dearborn, MI (US)

(72) Inventors: David Lloyd Nutt, Monroe, MI (US); Judith Sellars, Canton, MI (US); Kathleen Grab, Canton, MI (US); Doug Whiteman Smith, Farmington Hills, MI (US); Stuart C. Salter, White Lake, MI (US)

(73) Assignee: Ford Global Technologies, LLC, Dearborn, MI (US)

(21) Appl. No.: 19/051,892

(22) Filed: Feb. 12, 2025

(51) Int. Cl. F16L 33/03

(52) U.S. Cl. CPC F16L 33/03

(57) ABSTRACT

A clamp that includes a body, a first protrusion, and a tab. The body is configured to be disposed about a conduit and includes a first end and a second opposing end. The first protrusion extends from the first end of the body. The tab is proximate the second opposing end of the body. The first protrusion is hidden by the tab in response to the body being in the open position and the first protrusion is exposed from the tab in response to the body being in the closed position.

### FIELD

The present disclosure relates to a clamp having a flag.

### BACKGROUND

The statements in this section merely provide background information related to the present disclosure and may not constitute prior art.

Vehicles may include a plurality of clamps to secure conduits (e.g., hoses) to fittings. During visual or other forms of inspection of the vehicle, it may be a challenge to detect whether or not each clamp has been moved from the open position to the closed position. These issues related to detecting the positioning of the clamps, among other issues related to securing conduits to fittings using clamps, are addressed by the present disclosure.

### SUMMARY

This section provides a general summary of the disclosure and is not a comprehensive disclosure of its full scope or all of its features.

In one form, the present disclosure provides a clamp that includes a body, a first protrusion, and a tab. The body is configured to be disposed about a conduit and includes a first end and a second opposing end. The first protrusion extends from the first end of the body. The tab is proximate the second opposing end of the body. The first protrusion is hidden by the tab in response to the body being in the open position and the first protrusion is exposed from the tab in response to the body being in the closed position.

In variations of the clamp of the above paragraph, which can be implemented individually or in any combination: the body is biased towards the closed position; the body defines a slot, the first protrusion is received in the slot when the body is in the open position and the closed position; the tab extends over a portion of the slot; the first protrusion has an end surface comprising indicia; the first protrusion extends in a first direction and the tab extends in a second direction that is different from the first direction; the tab is planar or arcuate; the clamp further includes a second protrusion that extends from the second opposing end of the body, the tab extends from the second protrusion; the second protrusion extends in a first direction and the tab extends in a second direction that is different from the first direction; the clamp further includes a finger proximate the first end of the body, the finger engaging the second protrusion in response to the body being in the open position and disengaged from the second protrusion in response to the body being in the closed position; the second protrusion extends outwardly from the body a further distance than the first protrusion; and the body is arcuate.

In another form, the present disclosure provides a clamp that includes a body, a first protrusion, a second protrusion, and a tab. The body is configured to be disposed about a conduit. The body defining a slot and includes a first end and a second opposing end. The first protrusion is received in the slot of the body and extends from the first end of the body. The second protrusion extends from the second opposing end of the body. The tab extends from the second protrusion over a portion of the slot. The first protrusion is hidden by the tab in response to the body being in the open position and the first protrusion is exposed from the tab in response to the body being in the closed position.

In variations of the clamp of the above paragraph, which can be implemented individually or in any combination: the first protrusion is configured to traverse the slot as the body is moved between the open position and the closed position; the first protrusion has an end surface comprising indicia; the first protrusion extends in a first direction and the tab extends in a second direction that is different from the first direction; the tab is planar or arcuate; and the second protrusion extends outwardly from the body a further distance than the first protrusion.

In yet another form, the present disclosure provides a method that includes disposing a clamp onto a conduit, moving the clamp from a pre-set position in which a protrusion proximate a first end of the clamp is hidden by a tab proximate a second opposing end of the clamp to a set position in which the protrusion is exposed from the tab, and identifying the protrusion in response to the clamp being moved to the set position. In one form, identifying the protrusion includes identifying the protrusion with a camera.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:
FIG. 1 is a perspective view of a clamp disposed about a conduit in the open position in accordance with the principles of the present disclosure;
FIG. 2 is a perspective view of the clamp of FIG. 1 disposed about the conduit in the closed position;
FIG. 3 is a perspective view of the clamp of FIG. 1 in the open position;
FIG. 4 is an end view of the clamp of FIG. 1 in the open position;
FIG. 5 is a perspective view of the clamp of FIG. 1 in the closed position;
FIG. 6 is an end view of the clamp of FIG. 1 in the closed position;
FIG. 7 is a block diagram showing components of a system including the clamp of FIG. 1; and
FIG. 8 is a flowchart depicting an algorithm for detecting a position of the clamp of FIG. 1 in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

With reference to FIGS. 1 and 2, a clamp 10 is illustrated. The clamp 10 may be disposed over a first conduit 12 (e.g., a pipe, fitting, or sleeve) of a vehicle 14 and may be movable between an open position (FIG. 1; i.e., pre-set position) and a closed position (FIG. 2; i.e., set position). In the open position, a portion of the first conduit 12 may contact a second conduit 16 (e.g., a pipe, fitting, or sleeve) and the first conduit 12 and the second conduit 16 may be movable relative to each other. In the closed position, a greater portion of the first conduit 12 may contact the second conduit 16 and the first conduit 12 and the second conduit 16 may be inhibited from moving relative to each other. In this way, the clamp 10 provides a clamping force to the first and second conduits 12, 16. In the example illustrated, the second conduit 16 is at least partially received within the first conduit 12. In one form, the first conduit 12 and the second conduit 16 may be of different materials. That is, the first conduit 12 may be rubber and the second conduit 16 may be metal. It should be understood that the vehicle 14 may be an electric vehicle (e.g., a battery electric vehicle (BEV), a hybrid electric vehicle (HEV), a plug-in electric vehicle (PHEV), or a fuel cell vehicle) or a vehicle having an internal combustion engine (i.e., ICE vehicle). This application could be used beyond the automotive industry (washing machines, appliances, building construction, etc.) It should also be understood that the first and second conduits 12, 16 may be conduits containing fluid or conduits containing electrical components (e.g., wires), for example.

As will be described in more detail below, the clamp 10 provides enhanced visibility to detect between the open position and the closed position. In one form, an operator may detect between the open position and the closed position of the clamp 10. In another form, a sensor (e.g., a camera or other vision system) may detect between the open position and the closed position of the clamp 10.

In the example illustrated, the clamp 10 may be a monolithic, unitary component and may be made of metal. In some forms, the clamp 10 may include multiple components assembled to each other. With reference to FIGS. 3-6, the clamp 10 includes a body 20, first and second protrusions 22, 24, a finger 26, and a tab or flag 28. In the example illustrated, the body 20 is arcuate. Stated differently, the body 20 has a generally circular shape and has a biasing force that biases the body 20 toward the closed position. The body 20 defines one or more slots 30, 32 and has a first end 34a and a second opposing end 34b. The slot 30 may open through the second end 34b such that the slot 30 receives the first protrusion 22, which will be described in more detail below. The body 20 also defines an inner cylindrical surface 36a and an outer cylindrical surface 36b. The slot 30 also opens through the inner cylindrical surface 36a and the outer cylindrical surface 36b. The second end 34b of the body 20 has a length (i.e., axial length) that is greater than a length of the first end 34a of the body 20. In this way, the first end 34a of the body 20 may be received in the slot 30 formed near or at the second end 34b.

With continued reference to FIGS. 3-6, the first protrusion 22 extends from the body 20 in a direction away from a center of the body 20. In the example illustrated, the first protrusion 22 extends from the first end 34a of the body 20 in a radial direction. The first protrusion 22 is also received in the slot 30 of the body 20 and is configured to traverse the slot 30 as the clamp 10 moves between the open position and the closed position. That is, the first protrusion 22 may be located at an end of the slot 30 that opens through the end 34b of the body 20 when the clamp 10 is in the open position (FIG. 3), and the protrusion 22 may be located at or near an opposite end of the slot 30 when the clamp 10 is in the closed position (compare FIGS. 3 and 5). An end surface of the first protrusion 22 may include indicia 38 to facilitate identification of the first protrusion 22 when the clamp 10 is in the closed position. In this way, detection of the clamp 10 in the closed position may be facilitated. In one form, the indicia 38 may include material such as printed material, for example. In one form, the printed material may include bright paint (e.g., long or short persistence, phosphor paint), which may illuminate in response to exposure to light (e.g., daylight, blue light, or ultraviolet A (UVA) light).

The second protrusion 24 extends from the body 20 in a direction away from a center of the body 20. In the example illustrated, the second protrusion 24 extends from the second end 34b of the body 20 in a generally radial direction. The second protrusion 24 extends outwardly from the body 20 a further distance than the first protrusion 22. The second protrusion 24 includes opposing arms 40 and one or more connecting members 42. The connecting members 42 may be spaced apart from each other and may connect the opposing arms 40 to each other.

The finger 26 extends from the body 20 proximate the first end 34a. Stated differently, the finger 26 extends from the body 20 away from the center of the body 20. The finger 26 is configured to engage one side of the second protrusion 24 when the clamp 10 is in the open position and is configured to engage another side (i.e., bottom) of the second protrusion 24 when the clamp 10 is in the closed position. That is, a tool (not shown) may actuate the finger 26 to move the finger 26 from one side of the connecting member 42 to another side of the connecting member 24. This, in turn, allows the biasing force to move the clamp 10 toward the closed position (compare FIGS. 4 and 6). The finger 26 is located on one side of the second protrusion 24 when the clamp 10 is in the open position, and is located on the opposite side of the second protrusion 24 when the clamp 10 is in the closed position.

In the example illustrated, the tab 28 extends from an end of the second protrusion 24 over at least a portion of the slot 30. In some forms, the tab 28 extends from the second protrusion 24 at a location between the ends of the second protrusion 24. The first protrusion 22 and indicia 38 are hidden by the tab 28 (i.e., the tab 28 covers the end surface of the first protrusion 22 such that the first protrusion 22 and the indicia 38 are underneath the tab 28) in response to the clamp 10 being in the open position, and are exposed from the tab 28 in response to the clamp 10 being in the closed position. In the example illustrated, the tab 28 is a thin metal material having a planar shape (i.e., the thickness of the tab 28 maybe less than a thickness of the body 20). In some forms, the tab 28 has an arcuate shape. As shown in the figures, the tab 28 extends in a different direction than the first and second protrusions 22, 24. The tab 28 is spaced apart from the first protrusion 22 and is spaced apart from the body 20 of the clamp 10. It should be understood that the position of the tab 28 remains unchanged as the clamp 10 moves between the open position and the second position. In this way, the first protrusion 22 moves relative to the tab 28. The tab 28 has a predetermined length, which hides the first protrusion 22 when the clamp 10 is in the open position and exposes the first protrusion 22 when the clamp 10 is in the closed position.

With reference to FIG. 7, one or more sensors 50 may be disposed in the area of the clamp 10 and may be configured to detect a position of the clamp 10. That is, the sensors 50 are configured to detect the indicia 38 on the first protrusion 22 when the clamp 10 is moved to the closed position. In one form, the sensors 50 may be cameras, area reflective sensors or any other devices that are capable of detecting or identifying the indicia 38 on the first protrusion 22. A controller 52 may be in communication with the sensors 50 and may receive data from the sensors 50. The controller 52 may also instruct the sensors 50 to obtain data from clamp 10 and may also alert or notify a user when the clamp 10 has been moved to the closed position (i.e., when the sensors 50 have detected the indicia 38 on the clamp 10). The clamp 10, the sensors 50, and the controller 52 form a system for identifying or detecting the position of the clamp 10.

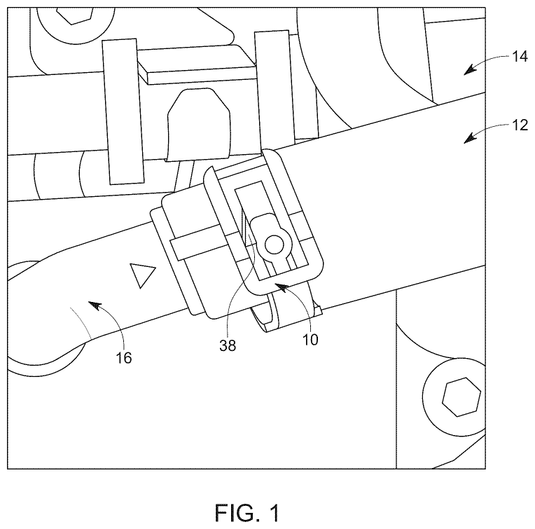

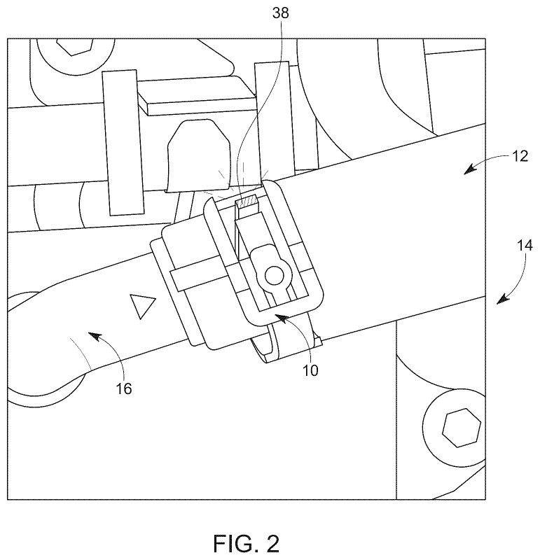

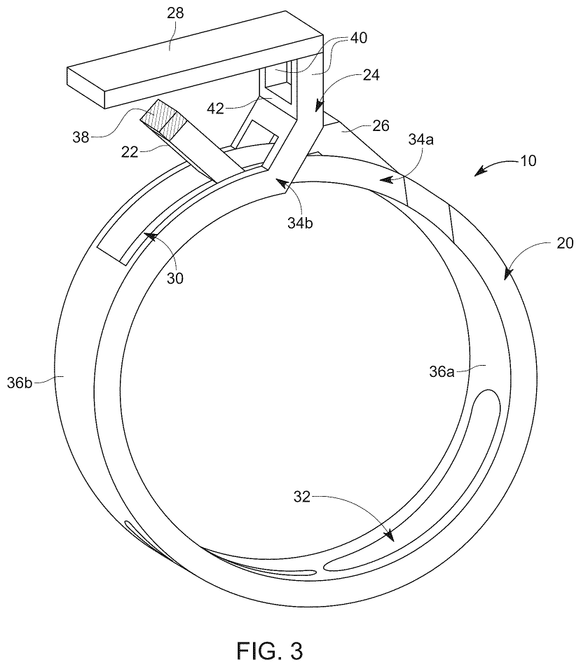

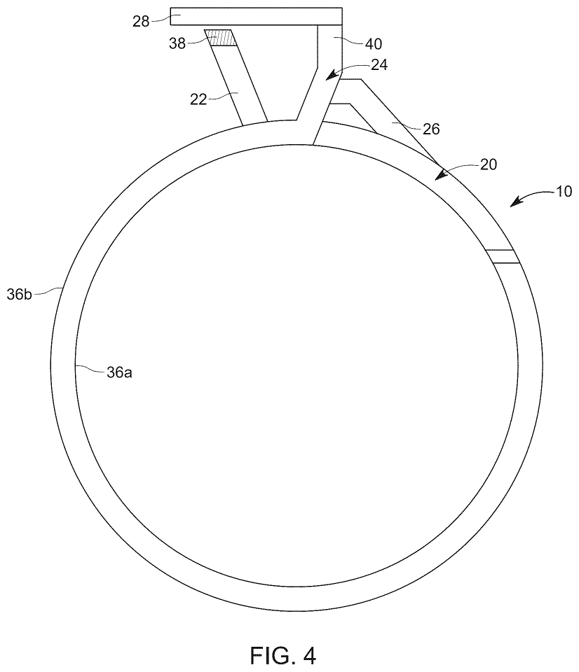

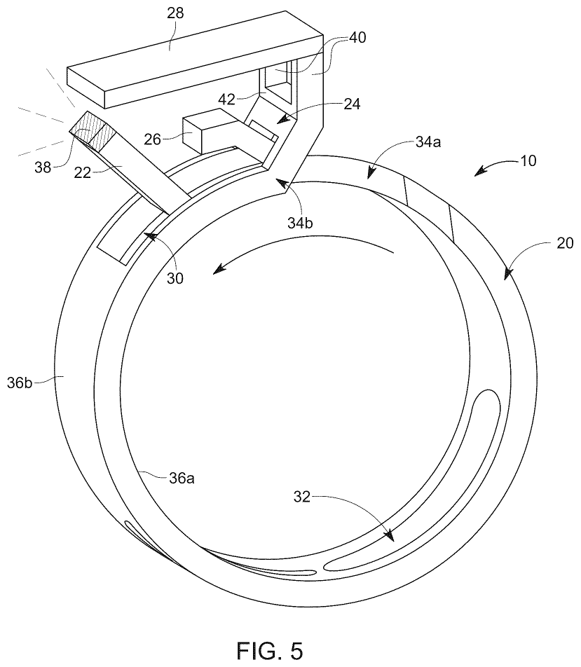

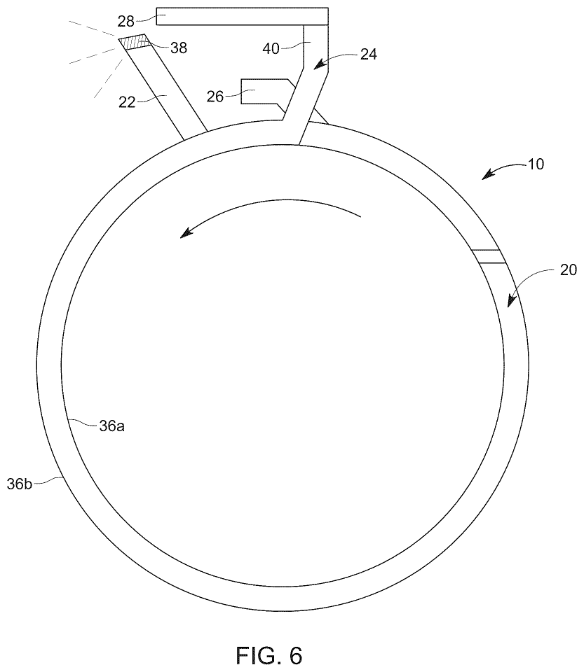

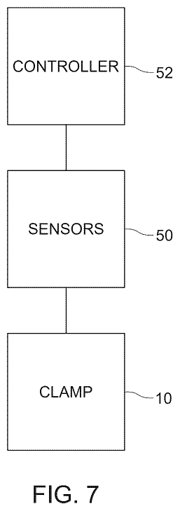

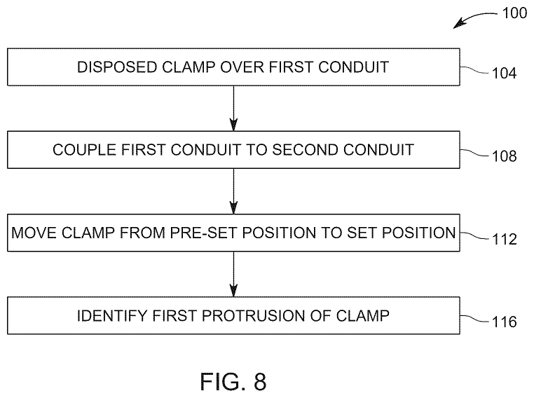

With reference to FIG. 8, a method 100 for detecting a position of the clamp 10 will be described in detail. In one form, the method may begin once the clamp 10 is moved to a predetermined area within a manufacturing facility. At 104, the clamp 10 is disposed onto the first conduit 12. At 108, the first conduit 12 is coupled to the second conduit 16 (e.g., disposed over the second conduit 16). It should be understood that, in some forms, the first conduit 12 is coupled to the second conduit 16 prior to the clamp 10 being disposed onto the first conduit 12. At 112, the clamp 10 is moved from the pre-set position to the set position as described above. In this way, the first protrusion 22 is exposed from the tab 28. At 116, the first protrusion 22 is identified. In one form, the first protrusion 22 may be manually identified by an operator. In another form, the first protrusion 22 may be identified using the controller 52 and the sensors 50. The indicia 38 on the first protrusion 22 facilitates identification/detection of the first protrusion 22.

The clamp 10 of the present disclosure including the tab 28 and the indicia 38 provides enhanced visibility to detect between the open position and the closed position. In one form, an operator may detect between the open position and the closed position of the clamp 10. In another form, the sensors (e.g., cameras) may detect between the open position and the closed position of the clamp 10. In one form, the clamp 10 may be a Pre-Opened Pre-Positioned (POPP) clamp.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

1. A clamp comprising:
a body configured to be disposed about a conduit and including a first end and a second opposing end;
a first protrusion extending from the first end of the body; and
a tab proximate the second opposing end of the body,
wherein the first protrusion is hidden by the tab in response to the body being in the open position and the first protrusion is exposed from the tab in response to the body being in the closed position.

2. The clamp of claim 1, wherein the body is biased towards the closed position.

3. The clamp of claim 1, wherein the body defines a slot, and wherein the first protrusion is received in the slot when the body is in the open position and the closed position.

4. The clamp of claim 3, wherein the tab extends over a portion of the slot.

5. The clamp of claim 1, wherein the first protrusion has an end surface comprising indicia.

6. The clamp of claim 1, wherein the first protrusion extends in a first direction and the tab extends in a second direction that is different from the first direction.

7. The clamp of claim 1, wherein the tab is planar or arcuate.

8. The clamp of claim 1, wherein a second protrusion extends from the second opposing end of the body, and wherein the tab extends from the second protrusion.

9. The clamp of claim 8, wherein the second protrusion extends in a first direction and the tab extends in a second direction that is different from the first direction.

10. The clamp of claim 8, further comprising a finger proximate the first end of the body, the finger engaging the second protrusion in response to the body being in the open position and disengaged from the second protrusion in response to the body being in the closed position.

11. The clamp of claim 8, wherein the second protrusion extends outwardly from the body a further distance than the first protrusion.

12. The clamp of claim 1, wherein the body is arcuate.

13. A clamp comprising:
a body configured to be disposed about a conduit, the body defining a slot and including a first end and a second opposing end;
a first protrusion received in the slot of the body and extending from the first end of the body;
a second protrusion extending from the second opposing end of the body; and
a tab extending from the second protrusion over a portion of the slot,
wherein the first protrusion is hidden by the tab in response to the body being in the open position and the first protrusion is exposed from the tab in response to the body being in the closed position.

14. The clamp of claim 13, wherein the first protrusion is configured to traverse the slot as the body is moved between the open position and the closed position.

15. The clamp of claim 13, wherein the first protrusion has an end surface comprising indicia.

16. The clamp of claim 13, wherein the first protrusion extends in a first direction and the tab extends in a second direction that is different from the first direction.

17. The clamp of claim 13, wherein the tab is planar or arcuate.

18. The clamp of claim 13, wherein the second protrusion extends outwardly from the body a further distance than the first protrusion.

19. A method comprising:
disposing a clamp onto a conduit;
moving the clamp from a pre-set position in which a protrusion proximate a first end of the clamp is hidden by a tab proximate a second opposing end of the clamp to a set position in which the protrusion is exposed from the tab; and
identifying the protrusion in response to the clamp being moved to the set position.

20. The method of claim 19, wherein identifying the protrusion includes identifying the protrusion with a camera.
